(19) United States
(12) Patent Application Publication
(10) Pub. No.: US 2026/0281436 A1
(43) Pub. Date: Sep. 17, 2026

(54) METHODS AND APPARATUS OF CROSS-COMPONENT CHROMA LINEAR TRANSFORMATION FOR VIDEO CODING

(71) Applicant: MEDIATEK INC., Hsinchu City (TW)

(72) Inventors: Hong-Hui CHEN, Hsinchu City (TW); Chih-Yao CHIU, Hsinchu City (TW); Cheng-Yen CHUANG, Hsinchu City (TW); Chia-Ming TSAI, Hsinchu City (TW); Chen-Yen LAI, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW)

(21) Appl. No.: 19/472,653

(22) PCT Filed: Jul. 4, 2024
(86) PCT No.: PCT/CN2024/103572

§ 371 Date: Oct. 4, 2025

Related U.S. Application Data
(60) Provisional application No. 63/515,848, filed on Jul. 27, 2023.
(60) Provisional application No. 63/595,383, filed on Nov. 2, 2023.

(51) Int. Cl. H04N 19/60; H04N 19/176; H04N 19/186

(52) U.S. Cl. CPC H04N 19/60; H04N 19/176; H04N 19/186

(57) ABSTRACT

A method and apparatus for video coding using CCCLT (Cross-Component Chroma Linear Transform) are disclosed. For the decoder side, input data associated with a current block in a current picture comprising a luma component and two or more second chroma components in a second chroma format is received. The input data comprises coded data associated with the current block to be decoded. Forward CCCLT was applied to two or more first chroma components in a first chroma format to generate said two or more second chroma components in the second chroma format during an encoding process. Backward CCCLT is applied to reconstructed two or more second chroma components in the second chroma format during a reconstruction process to generate reconstructed two or more first chroma components in the first chroma format. Output video comprising said reconstructed two or more first chroma components in the first chroma format is provided.

### CROSS REFERENCE TO RELATED APPLICATIONS

The present invention is a non-Provisional application of and claims priority to U.S. Provisional Patent Application No. 63/515,848, filed on Jul. 27, 2023 and U.S. Provisional Patent Application No. 63/595,383, filed on Nov. 2, 2023. The U.S. Provisional patent applications are hereby incorporated by reference in their entireties.

### FIELD OF THE INVENTION

The present invention relates to video coding system. In particular, the present invention discloses cross-component chroma linear transform to convert chroma components to another chroma format in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals. An overview of the Versatile Video Coding (VVC) standard has been published by Bross, et. al., “Overview of the Versatile Video Coding (VVC) Standard and Its Applications” in IEEE Transactions On Circuits and Systems for Video Technology, VOL. 31, No. 10, October 2021, pp. 3736-3764.

VVC uses adaptive intra/inter prediction with quantization and transform coding for the prediction residuals similar to prior video coding standards. However, VVC also incorporates various newer coding tools. FIG. 1 illustrates an exemplary block diagram for a VVC encoder. VVC also uses block based coding, where each input picture is partitioned into CTUs (Coding Tree Units) with a typical size of 128×128 or 64×64. The input video often uses 4:2:0 YCbCr format, where Cb and Cr are in ¼ resolution (½ in both horizontal and vertical directions) of the luma component.

The input video sequence in 4:2:0 YCbCr format can be converted from a 4:4:4 RGB video through a predefined conversion process. Human eyes are less sensitive to chroma information. Therefore, a spatial down-sampling procedure is applied to the chroma channels and only ¼ amount of the samples for luma are kept for chroma. After decoding, if a display device requires 4:4:4 RGB format for displaying the frames, the decoded 4:2:0 YCbCr video can be converted to the format required by display device for viewing.

As shown in FIG. 1, the Input Video Signal 102 is subtracted by prediction signal 111 using subtractor 112. The output from subtractor 112 corresponds to the residual signal. For VVC, Luma Mapping 110 is applied to input video signal 102 prior to prediction. Beside Intra-Picture Prediction 142 and Inter-Picture Prediction 146, VVC also introduces a new prediction type, named Combined Inter/Intra Prediction (CIIP, 144). The Inter-Picture Prediction 146 is based on reconstructed pictures stored at Decoded Picture Buffer 170 and motion information from Motion Estimation 148. Since the input video signal undergoes Luma Mapping 110, a corresponding process (i.e., Luma Mapping 114) is applied to the output from Inter-Picture Prediction 146 before it can be selected and used as prediction signal 111. A selection mechanism 116 is used to adaptively select among Intra-Picture Prediction 142, Inter-Picture Prediction 146, and Combined Inter/Intra Prediction (CIIP, 144).

Similar to HEVC, the residual signal from subtractor 112 undergoes Transform, Scaling and Quantization process 120 to generate quantized transform coefficients (labelled as “B”). The encoder side also needs to generate reconstructed pictures for coding process of subsequent pictures. In order to generate reconstructed pictures, Scaling and Inverse Transform process 130 is applied to the quantized transform coefficients (labelled as “B”) to generate reconstructed residuals. VVC also introduces Chroma Scaling 132 applied to the reconstructed residuals. After chroma scaling, the reconstructed residuals are added to prediction signal 111 to form reconstructed signal. For intra prediction, the reconstructed signal can be used directly without in-loop filtering. For inter prediction, the reconstructed residuals undergo Inverse Luma Mapping, Deblocking, SAO (Sample Adaptive Offset) and ALF (Adaptive Loop Filter) 160. Since luma mapping has been applied to the input video signal, inverse luma mapping has to be applied in the reconstruction path. VVC selects filter parameters adaptively. In order to determine filter parameters, Filter Control Analysis 150 determines filter parameters based on Input Video Signal 102 and the reconstructed residuals.

In the encoder, there are various process modules that require to decide mode, parameters or other control information. For example, the prediction mode selection 116 will decide whether to use intra, inter or CIIP mode based on mode selection information from General Coder Control 190. Furthermore, General Coder Control 190 also provide control information to Intra-Picture Estimation 140, Inter-Picture Estimation 146, and Scaling and Inverse Transform 130. The quantized transform coefficients (labelled as “B”) from Transform, Scaling and Quantization process 120 will be coded by Header Formatting and CABAC (Context-Adaptive Binary Arithmetic Coding) 180 to include in the coded bitstream. In addition, various related coder information, such as general coder control information (labelled as “A”), intra-prediction mode information (labelled as “C”) from Intra-Picture Estimation 140, inter-prediction mode information (labelled as “E”) from Inter-Picture Estimation 146, and filter control information (labelled as “D”) from Filter Control Analysis 150 will be included in the coded bitstream using Header Formatting and CABAC 180.

Since the encoder also needs to generate reconstructed signal and uses it for prediction, the encoder comprises some key processing units as used by the decoder. The processing modules that are also used by the decoder are shown in grey colour in FIG. 1. The coded bitstream is received at the decoder side. A module to perform the reverse function of Header Formatter and CABAC 180 is used to recover the quantized transform coefficients (labelled as “B”) along with various side information or control information (i.e., “A”, “C”, “D”, and “E” indicated in FIG. 1). The decoder operates on the quantized transform coefficients to generate reconstructed video. At the decoder, the intra-prediction mode information and inter-prediction motion information can be generated with needed side information (i.e., “C” and “F”). However, for Decoder-side Intra Mode Derivation (DIMD), the decoder will derive the mode information without the need for signalling from the encoder.

Recently, Motion Compensated Temporal Filtering (MCTF) has been disclosed by P. Wennersten, et al. (“AHG10: Encoder-only GOP-based temporal filter”, Joint Video Experts Team (JVET) of ITU-T SG 16 WP 3 and ISO/IEC JTC 1/SC 29/WG 11, 15th Meeting: Gothenburg, SE, 3-12 Jul. 2019, Document: JVET-O0549). The filtering is done at the encoder side as a pre-processing step, where a motion estimation and motion compensation method is applied on the neighbouring pictures on 8×8 luma blocks. With reference to the encoder system block diagram in FIG. 1, the MCTF process is located prior to the input video signal 102.

In the present invention, methods and apparatus to use cross-component chroma linear transform are disclosed to improve the performance, where the chroma components in a first format are converted to chroma components in another format through a set of linear equations.

### BRIEF SUMMARY OF THE INVENTION

A method and apparatus for video coding using cross-component chroma linear transform are disclosed. For the decoder side, input data associated with a current block in a current picture comprising a luma component and two or more second chroma components in a second chroma format is received, wherein the input data comprise coded data associated with the current block to be decoded, and wherein forward CCCLT (Cross-Component Chroma Linear Transform) was applied to two or more first chroma components in a first chroma format to generate said two or more second chroma components in the second chroma format during an encoding process. Backward CCCLT is applied to reconstructed two or more second chroma components in the second chroma format during a reconstruction process to generate reconstructed two or more first chroma components in the first chroma format. Output video comprising said reconstructed two or more first chroma components in the first chroma format is provided.

In one embodiment, the backward CCCLT is applied before deblocking process, after the deblocking process and before SAO (Sample Adaptive Offset) process, after the SAO process and before ALF (Adaptive Loop Filter) process, or after the ALF process.

In one embodiment, a flag is parsed to determine whether the forward CCCLT was applied to said two or more first chroma components in the first chroma format and whether the backward CCCLT is applied to the reconstructed two or more second chroma components.

In one embodiment, transform parameters for the backward CCCLT are determined for each sequence, each picture, each CTU (Coding Tree Unit) or each CU (Coding Unit). In one embodiment, one or more of the transform parameters for the backward CCCLT are selected from multiple sets of candidate parameters for said one or more of the transform parameters. In one embodiment, an index is received to indicate a target set among the multiple sets of candidates being selected for said one or more of the transform parameters.

In one embodiment, the transform parameters for the backward CCCLT are received from a bitstream at SPS (Sequence Parameter Set), PPS (Picture Parameter Set), CTU (Coding Tree Unit) or CU (Coding Unit) level. In another embodiment, one or more of the transform parameters for the backward CCCLT are updated based on one or more delta values.

In one embodiment, one or more of the transform parameters for the backward CCCLT are inherited from a neighbouring CTU or CU. In one embodiment, whether to enable inheriting said one or more of the transform parameters for the backward CCCLT is indicated by a flag. In one embodiment, a candidate that said one or more of the transform parameters are inherited from is indicated by an index.

In one embodiment, only if the current block is in an I-slice, or a P- or B-slice, the forward CCCLT was applied to said two or more first chroma components in the first chroma format and the backward CCCLT is applied to the reconstructed two or more second chroma components.

A method for the encoder side is also disclosed. At the encoder side, input data associated with a current block in a current picture comprising a luma component and two or more first chroma components is received, wherein the input data comprise pixel data to be encoded, and wherein said two or more first chroma components are in a first chroma format. Forward CCCLT (Cross-Component Chroma Linear Transform) is applied to said two or more first chroma components to generate two or more second chroma components in a second chroma format, wherein the forward CCCLT is applied during an encoding process to convert the chroma component from the original format to another format. Backward CCCLT is applied to reconstructed two or more second chroma components in the second chroma format during a reconstruction process to generate reconstructed two or more first chroma components in the first chroma format. Said reconstructed two or more first chroma components in the first chroma format and/or said reconstructed two or more second chroma components in the second chroma format are provided for processing of one or more subsequent blocks of the current block.

In one embodiment, the forward CCCLT is applied before MCTF (Motion Compensated Temporal Filtering), after the MCTF, or after JCCR (Joint Coding of Chroma Residuals) determination and before LC-RDO (Low Complexity Rate Distortion Optimization).

In one embodiment, a first reconstruct buffer is used for a first encoding process comprising said applying the forward CCCLT and said applying the backward CCCLT, a second reconstruct buffer is used for a second encoding process without said applying the forward CCCLT and without said applying the backward CCCLT, and said applying the forward CCCLT and said applying the backward CCCLT are selected if better performance is achieved by using said applying 10 the forward CCCLT and said applying the backward CCCLT.

In one embodiment, a first pass is performed for a first encoding process comprising said applying the forward CCCLT and said applying the backward CCCLT, a second pass is performed for a second encoding process without said applying the forward CCCLT and without said applying the backward CCCLT, and said applying the forward CCCLT and said applying the backward CCCLT are selected if better performance is achieved by the first pass. In one embodiment, the first pass and the second pass are performed at SPS (Sequence Parameter Set), PPS (Picture Parameter Set), CTU (Coding Tree Unit) or CU (Coding Unit) level.

In one embodiment, whether to use said applying the forward CCCLT and said applying the backward CCCLT is determined implicitly by using one or more templates outside a current CTU (Coding Tree Unit) or CU (Coding Unit).

### BRIEF DESCRIPTION OF THE DRAWINGS

FIG. 1 illustrates an exemplary system block diagram for a VVC encoder.

FIGS. 2A-B illustrate examples of deriving parameters or selection index for cross-component chroma linear transform using neural networks according to an embodiment of the present invention.

FIG. 3 illustrates a flowchart of an exemplary video decoding system that uses cross-component chroma linear transform according to an embodiment of the present invention.

FIG. 4 illustrates a flowchart of an exemplary video encoding system that uses cross-component chroma linear transform according to an embodiment of the present invention.

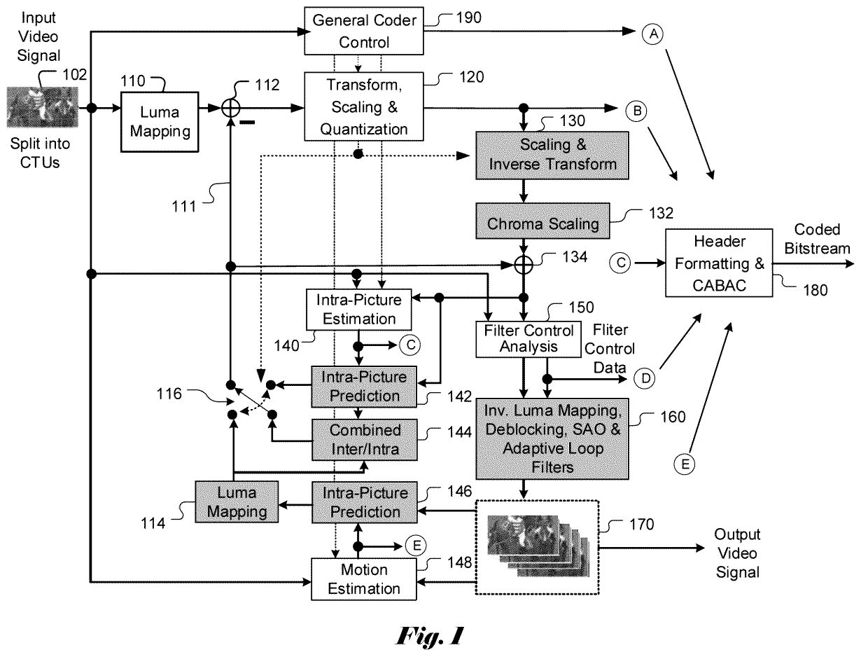

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Chroma components Cb and Cr have been widely used for video coding. In the present invention, cross-component chroma linear transformation is disclosed to convert chroma components to a different chroma format during encoding and/or decoding process in different levels of coding entities including sequence-level, picture-level, CTU-level, and CU-level entities. The formulas for the cross-component chroma linear transformation are disclosed first. Then different methods for encoding and/or decoding the video with the cross-component chroma linear transformation in different levels are described.

### Cross-Component Chroma Linear Transformation (CCCLT)

For video coding, colour video is often represented in luma (e.g. Y) and chroma (e.g. Cr and Cb) components. Furthermore, the colour format is fixed throughout all video sequences. On the other hand, the input video sequence is usually captured using a video camera, which outputs video in the RGB format. Therefore, the RGB video is converted to YCbCr format before the video data is processed by an encoder. In a typical video coding system, the video data stays in the YCbCr format during the entire encoding or decoding process. While the YCbCr format presumably works well to match the sensitivity of human colour vision, the YCbCr format, however may not always produce the best coding result in terms of bitrate or video quality. Accordingly, a technique for Cross-Component Chroma Linear Transformation (CCCLT) is disclosed in the present invention.

According to the present invention, cross-component chroma linear transformation is applied to the input chroma components (e.g. Cb and Cr) to convert the chroma components (e.g. Cb and Cr, named original chroma format in this disclosure) to other chroma format (e.g. Cp and Cq, named alternative chroma format) with the following formulas:

### Forward Transformation:

$$Cp = a * Cb + b * Cr + c , \qquad ( 1 )$$

$$Cq = d * Cb + e * Cr + f . \qquad ( 2 )$$

### Backward Transformation:

$$Cb = [ e * ( Cp - c ) - b * ( Cq - f ) ] / ( a * e - b * d ) , \qquad ( 3 )$$

$$Cr = [ d * ( Cp - c ) - a * ( Cq - f ) ] / ( b * d - a * e ) . \qquad ( 4 )$$

In the above equations, a, b, c, d, e and f are referred as transform parameters. An exemplary case for the transform parameters for a to f are used to encode 10-bit video: a=½, b=½, c=0, d=½, e=−½, f=512. Accordingly, the forward and backward transforms are shown as follows:

$$Cp = 1 / 2 * Cb + 1 / 2 * Cr + 0 = ( Cb + Cr ) / 2$$

$$Cq = 1 / 2 * Cb - 1 / 2 * Cr + 512 = ( Cb - Cr + 1024 ) / 2$$

$$Cb = [ - 1 / 2 * Cp - 1 / 2 * ( Cq - 512 ) ] / ( - 1 / 2 ) = Cp + Cq - 512$$

$$Cr = [ 1 / 2 * Cp - 1 / 2 * ( Cq - 512 ) ] / ( 1 / 2 ) = Cp - Cq + 512.$$

While the exemplary transform parameters are shown as above, other CCCLT transform parameters may also be used. The forward transformation can be applied during encoding process to generate coded bitstream. The backward transformation will be applied during the reconstruction process in order to convert the alternative chroma format back to the original chroma format.

The CCCLT according to the present invention can be adaptively applied to chroma components at different video data levels, such as sequence level, picture level, CTU level and CU level. Furthermore, the CCCLT can be applied to various locations with the encoding/decoding process. The details are described in the following proposed methods.

### Proposed Method A: Sequence-Level Cross-Component Chroma Linear Transformation

In this section, sequence-level Cross-Component Chroma Linear Transform (CCCLT) is disclosed, where the CCCLT is applied to the input video sequence. There are various scenarios of applying cross-component chroma linear forward transformation to input pictures of the video sequence, including:
Apply forward CCCLT transformation before MCTF (Motion Compensated Temporal Filtering) process.
Apply forward CCCLT transformation after MCTF process and before determining JCCR modes.
Apply forward CCCLT transformation after determining JCCR modes and before LC-RDO

In the above, JCCR stands for Joint Coding of Chroma Residuals, which is a coding tool introduced in VVC. JCCR exploits remaining correlations in the quantized chroma residual signal in which only one residual block is signalled and is used to derive residual blocks for both chroma components. The JCCR determination can be performed in General Coder Control 190. In the above, LC-RDO stands for “Low Complexity Rate Distortion Optimization”. It uses prediction and original pixels to calculate a cost (cost=estimated bits+lambda*distortion). The LC-RDO can be performed in General Coder Control 190. Sometime a Hadamard transform is utilized to mimic the real transform to approximate the transform coefficients to get the estimated bits. In the block diagram the “LC-RDO” and “JCCR” stages can be viewed as inside General Coder Control 190. JCCR uses LC-RDO's costs to determine the modes for HC-RDO (high complex rate distortion optimization) (as described by the following mode decision equations). The costs calculated in the original pixel domain or calculated in forward CCCLT domain may be different. According to one embodiment of the present invention, whether CCCLT is applied or not will affect JCCR modes at the LC-RDO stage. The selected JCCR modes by LC-RDO should compete with other coding modes in the HC-RDO stage for selecting the final best coding mode.

There are various locations for applying cross-component chroma linear backward transformation to pictures of the video sequence, including:
Apply backward CCCLT transformation before deblocking process.
Apply backward CCCLT transformation after deblocking process and before SAO process.
Apply backward CCCLT transformation after SAO process and before ALF process.
Apply backward CCCLT transformation after ALF process.

For some embodiments, the coefficients for the general cross-component chroma linear transformation can be a=½, b=½, c=0, d=½, e=−½, and f=512 as described earlier for encoding 10-bit video sequence. For another embodiment, a table with pre-defined group of forward transformation parameters is generated and the index for the selected group is signalled. Table 1 shows an example for groups of parameters.

TABLE 1
Pre-defined group of forward transformation parameters

| Index | Forward transformation |
|---|---|
| 0 | a = 1/2, b = 1/2, c = 0, d = 1/2, e = −1/2, f = 512 |
| 1 | a = 1/2, b = 1/2, c = 0, d = 1, e = −1/2, f = 256 |
| 2 | a = 1/2, b = 1/2, c = 0, d = 1/2, e = −1, f = 768 |
| 3 | a = 1/2, b = 1/2, c = 0, d = 1/2, e = 1/4, f = 128 |

For some embodiments, all the forward transformation parameters are signalled from the encoder to the decoder. For example, a=½, b=½, c=0, d=½, e=¼, and f=128 can be converted to proper representation and signalled in the bitstream. For another embodiment, partial forward transformation parameters are fixed and only some parameters are signalled. For example, a=½, b=½, c=0, d=½, and e=¼ are fixed parameters and the offset value “f” is signalled. To update the offset value “f”, the value can be signalled directly; otherwise the value can be signalled by an index referring to a value table as follows:

TABLE 2
Offset value indexing

| Index | Offset value “f” |
|---|---|
| 0 | 512 |
| 1 | 384 |
| 2 | 630 |
| 3 | 256 |
| 4 | 768 |

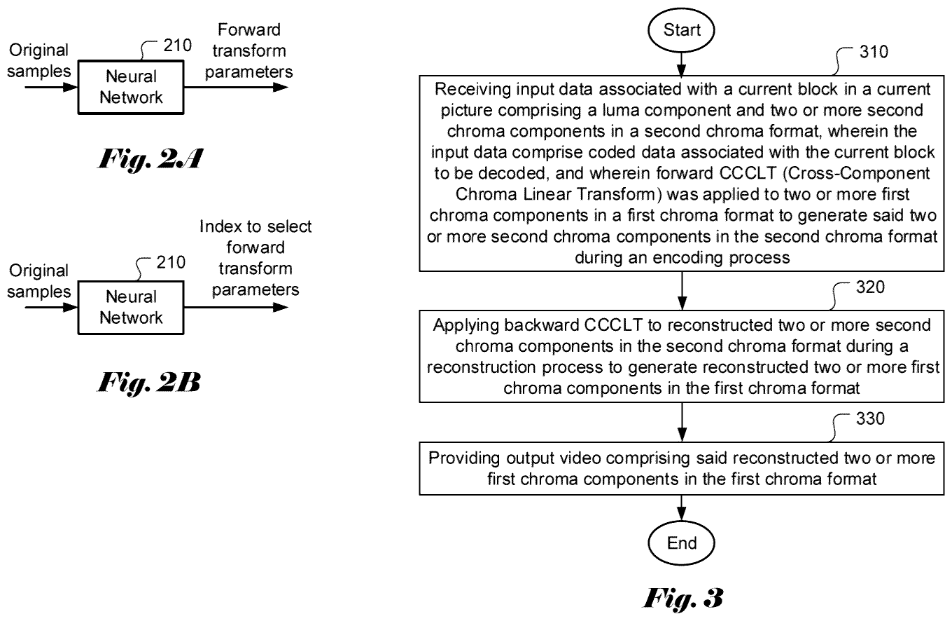

For another embodiment, a neural network is adopted to estimate the forward transformation parameters or an index to select an entry from parameter group table as depicted by FIG. 2A and FIG. 2B, where the neural network generates transform parameters (FIG. 2A) and an index to select the transform parameters (FIG. 2B) respectively.

For another embodiment, a default forward transformation is predefined or specified in the SPS header. For another embodiment, delta values of a, b, c, d, e, and f are signalled partially or completely by the sequence header to update these parameters with delta value. The delta value can be a value involving in mathematical calculation (addition, subtraction, multiplication, division, etc.). For example: new value=old value+delta value (where delta value can be positive or negative). Otherwise, the delta value can be used as an index referring a table to get a modification term for updating the parameters.

For some embodiments, a video sequence is encoded twice, one for encoding without CCCLT and the other for encoding with CCCLT. The bitstream with better rate-distortion performance is output as the final encoding result. For some embodiments, a detection process can be utilized for adaptively turning on/off the general cross-component chroma linear transformation. In Proposed Method H, several embodiments of detection method are disclosed. The detection is done once for the whole sequence. Statistics from the whole sequence or partial of the sequence can be used to conduct the detection. With this detection process, two times of the encoding runs can be reduced to one time run of the encoding process. An extra flag for the sequence-level enablement of the CCCLT is recorded in the SPS (sequence parameter set) or other sequence-level coding entities. For some embodiments, the cross-component chroma linear transformation is applied to all types of slice. For some embodiments, the cross-component chroma linear transformation is applied to I-slice. For some embodiments, the cross-component chroma linear transformation is applied to B-slice and/or P-slice.

### Proposed Method B: Picture-Level Cross-Component Chroma Linear Transformation

Some embodiments of applying general cross-component chroma linear forward transformation to a picture of a video sequence are disclosed, including:
Apply forward CCCLT transformation before MCTF process.
Apply forward CCCLT transformation after MCTF process and before determining JCCR modes.
Apply forward CCCLT transformation after determining JCCR modes and before LC-RDO

Some embodiments of applying general cross-component chroma linear backward transformation to a picture of a video sequence are disclosed, including:
Apply backward CCCLT transformation before deblocking process.
Apply backward CCCLT transformation after deblocking process and before SAO process.
Apply backward CCCLT transformation after SAO process and before ALF process.
Apply backward CCCLT transformation after ALF process.

In order to realize picture-level cross-component chroma linear transformation. We propose to maintain two reconstruction buffers. If forward CCCLT is applied to the current picture, we save the reconstructed samples after ALF process in one of reconstruction buffers. Then, we apply backward CCCLT transformation on reconstructed sample and save the result in the other reconstruction buffer. If forward CCCLT is not applied to the current picture, we save the reconstructed samples after ALF process in one of reconstruction buffers. Then, we apply forward CCCLT transformation on reconstructed samples and save the result in the other reconstruction buffer. Before saving reconstructed samples to reconstruction buffers, we propose to add padding to reconstructed samples to be used in the motion compensation process for future frames. Examples of adding padding to reconstructed samples include:
Add repetitive padding to reconstruction.
Add motion compensation padding to reconstructed sample after ALF process.

For some embodiments, the coefficients for the general cross-component chroma linear transformation can be a=½, b=½, c=0, d=½, e=−½, and f=512 as described in the Section of CCCLT for encoding 10-bit video sequence. For another embodiment, a table with pre-defined group of forward transformation parameters is generated and the index for the selected group is signalled as shown in Table 1. For some embodiments, all the forward transformation parameters are signalled from the encoder to the decoder. For another embodiment, partial forward transformation parameters are fixed and only some parameters are signalled. For example, a=½, b=½, c=0, d=½, and e=¼ are fixed parameters and the offset value “f” is signalled. To update the offset value “f”, the value can be signalled directly; otherwise the value can be signalled by an index referring to a value table as shown in Table 2. For another embodiment, a neural network is adopted to estimate the forward transformation parameters or an index to select an entry from parameter group table as depicted in FIG. 2. For another embodiment, a default forward transformation is predefined or specified in the SPS header. Delta values of a, b, c, d, e, and f are signalled partially or completely by the picture header or slice header to update these parameters with delta value. The delta value can be a value involving in mathematical calculation (addition, subtraction, multiplication, division, etc.). For example: new value=old value+delta value (where delta value can be positive or negative). Otherwise, the delta value can be used as an index referring a table to get a modification term for updating the parameters.

For some embodiments, a video frame is encoded twice, one for encoding without CCCLT and the other for encoding with CCCLT. The bitstream with better rate-distortion performance is output as the final encoding result for that frame. For some embodiments, a detection process can be utilized for adaptively turning on/off the general cross-component chroma linear transformation. The detection is done picture by picture while encoding the video sequence. Statistics from the whole frame or partial of the frame can be used to conduct the detection. In Section of proposed Method H, several embodiments of detection method are provided. With this detection process, two times of the encoding runs can be reduced to one time run of the encoding process. An extra flag for the picture-level enablement of the CCCLT is recorded in the PPS (picture parameter set) or PH (picture header) or other picture-level coding entities. For some embodiments, the cross-component chroma linear transformation is applied to all types of slice. For some embodiments, the cross-component chroma linear transformation is applied to I-slice. For some embodiments, the cross-component chroma linear transformation is applied to B-slice and/or P-slice.

### Proposed Method C: CTU-Level Cross-Component Chroma Linear Transformation

For some embodiments, before encoding a CTU, general cross-component chroma linear forward transformation can be applied to the CTU. The cross-component chroma linear backward transformation is applied to the reconstructed chroma samples before the processing of loop filtering, such as deblocking, SAO, ALF. For some embodiments, the coefficients for the general cross-component chroma linear transformation can be a=½, b=½, c=0, d=½, e=−½, and f=512 as described in the Section of CCCLT for encoding 10-bit video sequence. For another embodiment, a table with pre-defined group of forward transformation parameters is generated and the index for the selected group is signalled as shown in Table 1. for some embodiments, all the forward transformation parameters are signalled from the encoder to the decoder. For another embodiment, partial forward transformation parameters are fixed and only some parameters are signalled. For example, a=½, b=½, c=0, d=½, e=¼ are fixed parameters and the offset value “f” is signalled. To update the offset value “f”, the value can be signalled directly; otherwise the value can be signalled by an index referring to a value table as shown in Table 2. For another embodiment, a neural network is adopted to estimate the forward transformation parameters or an index to select an entry from parameter group table as depicted by FIG. 2A and FIG. 2B. For another embodiment, a default forward transformation is predefined or specified in the SPS/picture/slice header. Delta values of a, b, c, d, e, and f are signalled partially or completely by CTU-level syntax elements to update these parameters with delta value. The delta value can be a value involving in mathematical calculation (addition, subtraction, multiplication, division, etc.). For example: new value=old value+delta value (where delta value can be positive or negative). Otherwise, the delta value can be used as an index referring a table to get a modification term for updating the parameters.

For some embodiments, a CTU is encoded twice, one for encoding without CCCLT and the other for encoding with CCCLT. The bitstream with better rate-distortion performance is output as the final encoding result of that CTU. For some embodiments, a detection process can be utilized for adaptively turning on/off the general cross-component chroma linear transformation. Statistics from the whole CTU or partial of the CTU can be used to perform the detection. In Section of Proposed Method H, several embodiments of detection method are disclosed. With this detection process, two times of the encoding runs can be reduced to one time run of the encoding process. An extra flag for the CTU-level enablement of the CCCLT is recorded in a CTU-level field. For some embodiments, the cross-component chroma linear transformation is applied to all types of slice. For some embodiments, the cross-component chroma linear transformation is applied to I-slice. For some embodiments, the cross-component chroma linear transformation is applied to B-slice and/or P-slice.

### Proposed Method D: CU-Level Cross-Component Chroma Linear Transformation

For some embodiments, before encoding a chroma CU, general cross-component chroma linear forward transformation can be applied to the chroma CU. The cross-component chroma linear backward transformation is applied to the reconstructed chroma samples before the processing of loop filtering, such as deblocking, SAO, ALF. For some embodiments, the coefficients for the general cross-component chroma linear transformation can be a=½, b=½, c=0, d=½, e=−½, and f=512 as described in the Section of CCCLT for encoding 10-bit video sequence. For another embodiment, a table with pre-defined group of forward transformation parameters is generated and the index for the selected group is signalled as shown in Table 1. For some embodiments, all the forward transformation parameters are signalled from the encoder to the decoder. For another embodiment, partial forward transformation parameters are fixed and only some parameters are signalled. For example, a=½, b=½, c=0, d=½, e=¼ are fixed parameters and the offset value “f” is signalled. To update the offset value “f”, the value can be signalled directly; otherwise the value can be signalled by an index referring to a value table as shown in Table 2. For another embodiment, a neural network is adopted to estimate the forward transformation parameters or an index to select an entry from parameter group table as depicted in FIG. 2A and FIG. 2B. For another embodiment, a default forward transformation is predefined or specified in the SPS/picture/slice header or by CTU-level syntax elements. Delta values of a, b, c, d, e, and f are signalled partially or completely by CU-level syntax elements to update these parameters with delta value. The delta value can be a value involving in mathematical calculation (addition, subtraction, multiplication, division, etc.). For example: New value=old value+delta value (where delta value can be positive or negative). Otherwise, the delta value can be used as an index referring a table to get a modification term for updating the parameters.

For some embodiments, a CU is encoded twice, one for encoding without CCCLT and the other for encoding with CCCLT. The bitstream with better rate-distortion performance is output as the final encoding result of that chroma CU. For some embodiments, a detection process can be utilized for adaptively turning on/off the general cross-component chroma linear transformation. Statistics from the whole CU or partial of the CU can be used to conduct the detection. In Section of Proposed Method H, several embodiments of detection method are disclosed. With this detection process, two times of the encoding runs can be reduced to one time run of the encoding process. An extra flag for the CU-level enablement of the CCCLT is recorded in a CU-level field. For some embodiments, the cross-component chroma linear transformation is applied to all types of slice. For some embodiments, the cross-component chroma linear transformation is applied to I-slice, for some embodiments, the cross-component chroma linear transformation is applied to B-slice and/or P-slice.

### Proposed Method E: Spatial Filtering on Chroma Samples

Proposed Methods A and D utilize a forward and backward transformation pair. In this section, we propose to apply a spatial filter to chroma, such as 3×3 or 5×5 Gaussian filter. There is no inversion of this spatial filtering. An extra flag is introduced for enabling this spatial filtering. The flag can be a sequence/picture/CTU/CU-level syntax element. For some embodiments, the encoding process is conducted twice to select a better coding mode between enabling or disabling of this spatial filtering. For some embodiments, a detection process can be utilized for adaptively turning on/off the spatial filtering. Statistics from the sequence/picture/CTU/CU or partial of the sequence/picture/CTU/CU can be used to conduct the detection. In the Section of Proposed Method H, several embodiments of detection method are disclosed. With this detection process, two times of the encoding runs can be reduced to one time run of the encoding process. For some embodiments, the spatial filtering is applied to all types of slice. For some embodiments, the spatial filtering is applied to I-slice. For some embodiments, the spatial filtering is applied to B-slice and/or P-slice.

### Proposed Method F: Apply Spatial Filtering on Other Types of Samples

The methods mentioned in previous sections are applied to original samples before encoding. The spatial filtering process can be applied to prediction samples of the chroma component. An extra flag is introduced for enabling this spatial filtering. The flag can be a sequence/picture/CTU/CU-level syntax element.

### Proposed Method G: CCCLT Merge Mode

To reduce the overhead of signalling forward transformation parameters, these parameters can be inherited from neighbouring area. This is commonly referred as merge mode where the same coding parameters propagate from the neighbouring CTU or CU to current CTU or CU. An additional flag is signalled for enabling the inheritance for this CCCLT merge mode. The candidates for inheritance can be top CTU/CU, left CTU/CU, top-left CTU/CU, top-right CTU/CU, bottom-left CTU/CU for I-slice, B-slice and P-slice. For B-slice and P-slice, temporal candidates (in reference frames) can be used, for example, the temporal collocated CTU/CU and/or adjacent CTUs/CUs of the collocated CTU/CU. Sometimes, there may be more than one inheritance candidate. For example, both top CTU/CU and left CTU/CU are coded with CCCLT modes. Assuming top CTU/CU is the first candidate (index=0) and left CTU/CU is the second candidate (index=1), the inherited candidate can be specified by signalling an index, so-called merge index. In this case, 0 or 1 is signalled to determine the final merge candidate.

### Proposed Method H: CCCLT Detection Methods

In one embodiment, the difference between the mean of variance of chroma sub-block before applying CCCLT and the mean of variance of chroma sub-block after applying CCCLT can be used to determine the CCCLT flag. For example, the target region (e.g., picture, CTU or CU) can be divided into several chroma sub-blocks, and each chroma sub-block contains M×N chroma samples, where M and N are positive integers larger than 1. A variance is calculated for each chroma sub-block, and then the mean variance of all chroma sub-blocks is calculated. If the difference between the mean variance before applying CCCLT and the mean variance after applying CCCLT is larger than a pre-defined threshold, CCCLT is enabled.

In another embodiment, the difference between the median of variance of chroma sub-block before applying CCCLT and the median of variance of chroma sub-block after applying CCCLT can be used to determine the CCCLT flag. For example, the target region (e.g., picture, frame, CTU or CU) can be divided into several chroma sub-blocks, and each chroma sub-block contains M×N chroma samples, where M and N are positive integers larger than 1. A variance is calculated for each chroma sub-block, and then the median variance of all chroma sub-blocks is calculated. If the difference between the median variance before applying CCCLT and the median variance after applying CCCLT is larger than pre-defined threshold, CCCLT is enabled.

In another embodiment, principal components analysis (PCA) can be used to determine the CCCLT flag. For example, PCA can be applied to the two chroma components of target region (e.g., picture, frame, CTU or CU) first, and then we can get a first principal component and a second principal component. If the CCCLT transform is similar to the first principal component or the second principal component, CCCLT is enabled.

In another embodiment, the difference between the regression matching loss before applying CCCLT and the regression matching loss after applying CCCLT can be used to determine the CCCLT flag. For example, one cross-component model (e.g., Cross-component linear model, CCLM) of the target region (e.g., picture, frame, CTU or CU) is derived first. The input of this model is the luma component of the target region, and the output of this model is one of the chroma components of the target region. During the regression process, a regression matching loss can be obtained. If the regression matching loss after applying CCCLT is smaller than the regression matching loss before applying CCCLT, CCCLT is enabled. For another example, two cross-component models of the target region are derived. The output of one model is the Cb component of the target region, and the output of the other model is the Cr component of the target region. The total matching loss is the sum of the two regression matching losses, and the total matching loss is used to determine the CCCLT flag.

In one embodiment, the detection methods mentioned above can be used to determine the CCCLT flag in the encoder side for speed up the encoding algorithm.

In another embodiment, the detection methods mentioned above can be used to implicitly determine the CCCLT flag on the encoder side and the decoder side. If this implicit method is used, the CCCLT flag is not signalled. The detection methods can be applied to the reconstructed samples in the neighbouring template region.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

FIG. 3 illustrates a flowchart of an exemplary video decoding system that uses cross-component chroma linear transform according to an embodiment of the present invention. The steps shown in the flowchart may be implemented as program codes executable on one or more processors (e.g., one or more CPUs) at the decoder side. The steps shown in the flowchart may also be implemented based hardware such as one or more electronic devices or processors arranged to perform the steps in the flowchart. According to the method, at the decoder side, input data associated with a current block in a current picture comprising a luma component and two or more second chroma components in a second chroma format is received in step 310, wherein the input data comprise coded data associated with the current block to be decoded, and wherein forward CCCLT (Cross-Component Chroma Linear Transform) was applied to two or more first chroma components in a first chroma format to generate said two or more second chroma components in the second chroma format during an encoding process. Backward CCCLT is applied to reconstructed two or more second chroma components in the second chroma format during a reconstruction process to generate reconstructed two or more first chroma components in the first chroma format in step 320. Output video comprising said reconstructed two or more first chroma components in the first chroma format is provided in step 330.

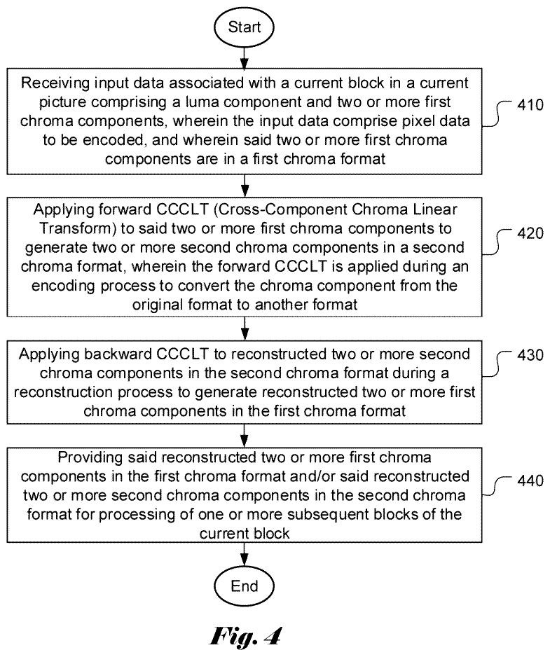

FIG. 4 illustrates a flowchart of an exemplary video encoding system that uses cross-component chroma linear transform according to an embodiment of the present invention. At the encoder side, input data associated with a current block in a current picture comprising a luma component and two or more first chroma components is received in step 410, wherein the input data comprise pixel data to be encoded, and wherein said two or more first chroma components are in a first chroma format. Forward CCCLT (Cross-Component Chroma Linear Transform) is applied to said two or more first chroma components to generate two or more second chroma components in a second chroma format, wherein the forward CCCLT is applied during an encoding process to convert the chroma component from the original format to another format before transform coding is applied in step 420. Backward CCCLT is applied to reconstructed two or more second chroma components in the second chroma format during a reconstruction process to generate reconstructed two or more first chroma components in the first chroma format in step 430. Said reconstructed two or more first chroma components in the first chroma format and/or said reconstructed two or more second chroma components in the second chroma format are provided for processing of one or more subsequent blocks of the current block in step 440.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving input data associated with a current block in a current picture comprising a luma component and two or more second chroma components in a second chroma format, wherein the input data comprises coded data associated with the current block to be decoded, and wherein forward CCCLT (Cross-Component Chroma Linear Transform) was applied to two or more first chroma components in a first chroma format to generate said two or more second chroma components in the second chroma format during an encoding process;
applying backward CCCLT to reconstructed two or more second chroma components in the second chroma format during a reconstruction process to generate reconstructed two or more first chroma components in the first chroma format; and
providing output video comprising said reconstructed two or more first chroma components in the first chroma format.

2. The method of claim 1, wherein the backward CCCLT is applied before deblocking process, after the deblocking process and before SAO (Sample Adaptive Offset) process, after the SAO process and before ALF (Adaptive Loop Filter) process, or after the ALF process.

3. The method of claim 1, wherein a flag is parsed to determine whether the forward CCCLT was applied to said two or more first chroma components in the first chroma format and whether the backward CCCLT is applied to the reconstructed two or more second chroma components.

4. The method of claim 1, wherein transform parameters for the backward CCCLT are determined for each sequence, each picture, each CTU (Coding Tree Unit) or each CU (Coding Unit).

5. The method of claim 4, wherein one or more of the transform parameters for the backward CCCLT are selected from multiple sets of candidate parameters for said one or more of the transform parameters.

6. The method of claim 4, wherein the transform parameters for the backward CCCLT are received from a bitstream at SPS (Sequence Parameter Set), PPS (Picture Parameter Set), CTU (Coding Tree Unit) or CU (Coding Unit) level.

7. The method of claim 4, wherein one or more of the transform parameters for the backward CCCLT are inherited from a neighbouring CTU or CU.

8. The method of claim 7, wherein whether to enable inheriting said one or more of the transform parameters for the backward CCCLT is indicated by a flag.

9. The method of claim 7, wherein a candidate that said one or more of the transform parameters are inherited from is indicated by an index.

10. The method of claim 1, wherein only if the current block is in an I-slice, or a P- or B-slice, the forward CCCLT was applied to said two or more first chroma components in the first chroma format and the backward CCCLT is applied to the reconstructed two or more second chroma components.

11. The method of claim 1, wherein whether to use said applying the forward CCCLT and said applying the backward CCCLT is determined implicitly by using one or more templates outside a current CTU (Coding Tree Unit) or CU (Coding Unit).

12. An apparatus for video decoding, the apparatus comprising one or more electronics or processors arranged to:
receive input data associated with a current block in a current picture comprising a luma component and two or more second chroma components in a second chroma format, wherein the input data comprises coded data associated with the current block to be decoded, and wherein forward CCCLT (Cross-Component Chroma Linear Transform) was applied to two or more first chroma components in a first chroma format to generate said two or more second chroma components in the second chroma format during an encoding process;
apply backward CCCLT to reconstructed two or more second chroma components in the second chroma format during a reconstruction process to generate reconstructed two or more first chroma components in the first chroma format; and
provide output video comprising said reconstructed two or more first chroma components in the first chroma format.

13. The apparatus of claim 12, wherein whether to use said applying the forward CCCLT and said applying the backward CCCLT is determined implicitly by using one or more templates outside a current CTU (Coding Tree Unit) or CU (Coding Unit).

14. A method of video encoding, the method comprising:
receiving input data associated with a current block in a current picture comprising a luma component and two or more first chroma components, wherein the input data comprises pixel data to be encoded, and wherein said two or more first chroma components are in a first chroma format;
applying forward CCCLT (Cross-Component Chroma Linear Transform) to said two or more first chroma components to generate two or more second chroma components in a second chroma format, wherein the forward CCCLT is applied during an encoding process to convert the chroma component from the original format to another format;
applying backward CCCLT to reconstructed two or more second chroma components in the second chroma format during a reconstruction process to generate reconstructed two or more first chroma components in the first chroma format; and
providing said reconstructed two or more first chroma components in the first chroma format and/or said reconstructed two or more second chroma components in the second chroma format for processing of one or more subsequent blocks of the current block.

15. The method of claim 14, wherein the forward CCCLT is applied before MCTF (Motion Compensated Temporal Filtering), after the MCTF, or after JCCR (Joint Coding of Chroma Residuals) determination and before LC-RDO (Low Complexity Rate Distortion Optimization).

16. The method of claim 15, wherein a first reconstruct buffer is used for a first encoding process comprising said applying the forward CCCLT and said applying the backward CCCLT, a second reconstruct buffer is used for a second encoding process without said applying the forward CCCLT and without said applying the backward CCCLT, and said applying the forward CCCLT and said applying the backward CCCLT are selected if better performance is achieved by using said applying the forward CCCLT and said applying the backward CCCLT.

17. The method of claim 14, wherein a first pass is performed for a first encoding process comprising said applying the forward CCCLT and said applying the backward CCCLT, a second pass is performed for a second encoding process without said applying the forward CCCLT and without said applying the backward CCCLT, and said applying the forward CCCLT and said applying the backward CCCLT are selected if better performance is achieved by the first pass.

18. The method of claim 17, wherein the first pass and the second pass are performed at SPS (Sequence Parameter Set), PPS (Picture Parameter Set), CTU (Coding Tree Unit) or CU (Coding Unit) level.

19. The method of claim 14, wherein whether to use said applying the forward CCCLT and said applying the backward CCCLT is determined implicitly by using one or more templates outside a current CTU (Coding Tree Unit) or CU (Coding Unit).

20. An apparatus for video encoding, the apparatus comprising one or more electronics or processors arranged to:
receive input data associated with a current block in a current picture comprising a luma component and two or more first chroma components, wherein the input data comprises pixel data to be encoded, and wherein said two or more first chroma components are in a first chroma format;
apply forward CCCLT (Cross-Component Chroma Linear Transform) to said two or more first chroma components to generate two or more second chroma components in a second chroma format, wherein the forward CCCLT is applied during an encoding process to convert the chroma component from the original format to another format;
apply backward CCCLT to reconstructed two or more second chroma components in the second chroma format during a reconstruction process to generate reconstructed two or more first chroma components in the first chroma format; and
provide said reconstructed two or more first chroma components in the first chroma format and/or said reconstructed two or more second chroma components in the second chroma format for processing of one or more subsequent blocks of the current block.
